(19) United States
(12) Patent Application Publication
(10) Pub. No.: US 2014/0108145 A1
(43) Pub. Date: Apr. 17, 2014

(54) DYNAMIC CONTENT ITEM CREATION

(71) Applicant: Google Inc., Mountain View, CA (US)

(72) Inventors: Chetan Patel, Fremont, CA (US); Vinod Ramachandran Marur, Palo Alto, CA (US); Beverly Yang, San Francisco, CA (US); Karen Yao, Los Altos, CA (US); Varouj A. Chitilian, Hillsborough, CA (US); Shu Niu, E. Palo Alto, CA (US); Nam Hoang Mai, Milpitas, CA (US)

(73) Assignee: Google Inc., Mountain View, CA (US)

(21) Appl. No.: 14/071,997

(22) Filed: Nov. 5, 2013

Related U.S. Application Data
(63) Continuation of application No. 13/836,879, filed on Mar. 15, 2013.
(60) Provisional application No. 61/713,229, filed on Oct. 12, 2012.

(51) Int. Cl. G06Q 30/02

(52) U.S. Cl. CPC G06Q 30/0256
USPC 705/14.54

(57) ABSTRACT

Methods, systems, and apparatus, including computer programs encoded on a computer storage medium, for creating advertisements are disclosed. In one aspect, a method includes receiving an advertisement request that includes user context data. An advertisement having distribution parameters matching the user context data is identified. The identified advertisement can include one or more variables that are resolved based on the user context data. A proper subset of feed data to which the one or more variables for the advertisement will be resolved can be selected based on the user context data and performance measures for portions of the feed data that have been previously used to resolve the one or more variables. The advertisement is modified, at least in part, by including, in place of the one or more variables, the selected modifying data. The modified advertisement is provided in response to the advertisement request.

### CROSS-REFERENCE TO RELATED APPLICATIONS

This application is a continuation of U.S. application Ser. No. 13/836,879, titled “DYNAMIC CONTENT ITEM CREATION” filed Mar. 15, 2013, which claims the benefit under 35 U.S.C. §119(e) of U.S. Patent Application No. 61/713,229, entitled “DYNAMIC CONTENT ITEM CREATION,” filed Oct. 12, 2012, which is incorporated herein by reference in its entirety.

### BACKGROUND

This specification relates to data processing and content distribution.

The Internet enables access to a wide variety of resources. For example, video, audio, webpages directed to particular subject matter, news articles, images, and other resources are accessible over the Internet. The wide variety of resources that are accessible over the Internet has enabled opportunities for content distributors to provide content items to users that request the resources. Content items are units of content (e.g., individual files or a set of files) that are presented in resources (e.g., web pages). A content item can include an active link that initiates a request for another resource in response to interaction with the content item. An advertisement is an example of a content item that advertisers can target for presentation with particular resources, such as web pages and search results pages. An advertisement can be made eligible for presentation with specific resources and/or resources that are determined to match specified distribution criteria, such as distribution keywords.

### SUMMARY

In general, one innovative aspect of the subject matter described in this specification can be embodied in methods that include the actions of receiving an advertisement request that includes user context data specifying user attributes for a user to whom the requested advertisement will be presented; identifying an advertisement having distribution parameters matching the user context data, the identified advertisement including one or more variables that are resolved based on the user context data; in response to receiving the advertisement request: selecting, as modifying data, a proper subset of feed data to which the one or more variables for the advertisement will be resolved, the selection being based on performance measures for portions of the feed data that have been previously used to resolve the one or more variables in response to previous advertisement requests that included at least one user attribute matching a user attribute in the user context data; modifying the advertisement to be provided in response to the advertisement request, the advertisement being modified, at least in part, by including, in place of the one or more variables, the selected modifying data; and providing the modified advertisement in response to the advertisement request. Other embodiments of this aspect include corresponding systems, apparatus, and computer programs, configured to perform the actions of the methods, encoded on computer storage devices.

These and other embodiments can each optionally include one or more of the following features. Methods can include the action of determining, after receiving the advertisement request, a bid for the advertisement based on the user context data. Determining a bid for the advertisement can include the actions of determining that at least one of the user attributes in the received advertisement request matches a bid change condition; and setting the bid for the advertisement to a value corresponding to the bid attribute.

Methods can further include the actions of obtaining, for each of a plurality of prior presentations of the advertisement, presentation summary data specifying: the user context data for previous advertisement requests in response to which the prior presentations occurred; performance data indicating whether user interaction with the presented advertisement occurred; and variable resolution data specifying the modifying data that were inserted in place of the one or more variables for the presentation of the advertisement. Method can further include the actions of determining, based on the presentation summary data and for each distinct set of modifying data, a performance measure for the advertisement when the distinct set of modifying data was included in place of the one or more variables.

Methods can further include the actions of determining that a particular distinct set of modifying data was included in place of the one or more variables for advertisement requests that specified two different distinct sets of user context data; and determining per-user-context performance measures for the particular distinct set of modifying data, each per-user-context performance measure specifying a performance of the advertisement when modified using the particular distinct set of modifying data and provided in response to advertisement requests that included a particular distinct set of user context data.

Selecting the modifying data can include identifying a plurality of different sets of candidate modifying data, each identified set of candidate modifying data being a proper subset of the feed data that have been identified as eligible data for resolving the one or more variables in response to an advertisement request that includes one or more of the specified user attributes; and selecting, as the modifying data, the set of candidate modifying data for which the advertisement has a highest performance measure. Selecting the set of candidate modifying data having a highest performance measure for the advertisement can include selecting the set of candidate modifying data for which the advertisement has a highest conversion rate.

Particular embodiments of the subject matter described in this specification can be implemented so as to realize one or more of the following advantages. Different customized advertisements can be created for many different groups of users. Different customized advertisements can also be created based on a type of device at which the advertisement will be presented, a time of day at which the advertisement is being provided, whether the user has previously visited the advertiser's website, and/or a geographic location corresponding to the user device. The content with which the customized advertisement is populated can be selected based on current inventory information and characteristics of the type of user to whom (or user device to which) the advertisement will be provided. The content with which the customized advertisement is populated can also be selected based on transaction information (e.g., when a room at an advertised hotel was last booked), temporal information (e.g., when an auction for a particular produce ends), and/or fulfillment information (e.g., when an advertised product can be shipped if ordered by a specified time). Changes to a single feed data entry can change multiple different customized advertisements, thereby reducing the work required by the advertiser to adjust advertisements.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content distribution system distributes content to user devices.

FIG. 2A is a block diagram of an example data flow for creating a customized advertisement.

FIG. 2B is a block diagram illustrating selection of feed data based on a matching function.

FIG. 3 is a flow chart of an example process for providing a customized advertisement.

FIG. 4 is block diagram of an example computer system.

Like reference numbers and designations in the various drawings indicate like elements.

### DETAILED DESCRIPTION

Content items (e.g., online advertisements, audio files, and/or video files) are selected for presentation in response to a content item request based, in part, on information included in the content item request. For example, a particular content item request may indicate that the requested content item will be presented in a search results page that is provided in response to submission of the search query “hotel”. In this example, the content item that is provided in response to the request can be selected based, at least in part, on the search query “hotel” matching a distribution keyword for the content item.

The selected content item can include one or more variables that act as placeholders for content that will be inserted into the advertisement prior to delivery of the advertisement. The content that will be inserted into the advertisement can be selected based on one or more user attributes associated with a user to whom the advertisement will be presented. For example, the content that is inserted into an advertisement that is provided to a male user from Atlanta may differ from the content that is provided to a male user from New York. The user attributes may be included in the content item request and/or obtained from a user profile that the user has created.

The selected content item can also include an advertisement extender that causes additional content to be inserted into the advertisement when extender criteria are met. For example, an advertiser can create sitelinks that can be used to extend an advertisement. A sitelink is content (e.g., text) that includes an active link to a page (e.g., other than the landing page for the advertisement) in the advertiser's site. The inclusion of advertisement extenders, such as sitelinks in an advertisement can be conditioned on extender conditions being met. For example, an advertiser can specify that a particular sitelink that redirects a user to one page of the advertiser's site be included in the advertisement when the advertisement will be presented to a person in New York. The advertiser can further specify that a different sitelink that redirects a user to another page of the advertiser's site is to be included in the advertisement when the advertisement will be presented to a person in Atlanta. Inclusion of an advertisement extender can increase the size of an advertisement. The description that follows describes inserting content in place of variables. Operations similar to those described below can be used to trigger the inclusion of an advertisement extender in an advertisement.

Particular content can be selected to be inserted into a content item based, at least in part, on historical performance of the content item when the particular content has been inserted into the content item relative to the historical performance of the content item when other content has been inserted into the content item. For example, some groups of users may respond better to (e.g., interact with more) advertisements that insert content for a category of product into a particular advertisement, while other groups of users may respond better to advertisements in which content for specific brands of products in the category are inserted into the advertisements. Thus, the particular content that is selected to be inserted into a content item can be based on an analysis of the performance of the content item when different combinations of content were inserted into the content item and provided to users having the combination of user attributes specified in the content item request. As described in more detail below, a bid for a content item can also be varied based on the combination of user attributes that are included in the content item request and/or historical performance data.

The description that follows generally describes modifying advertisements that are selected in response to an advertisement request. The description is also applicable to modifying other types of content items (e.g., video files, audio files, application scripts, or other content) that is requested through other content item requests.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, users may have control over how information is collected about them and used by a content server.

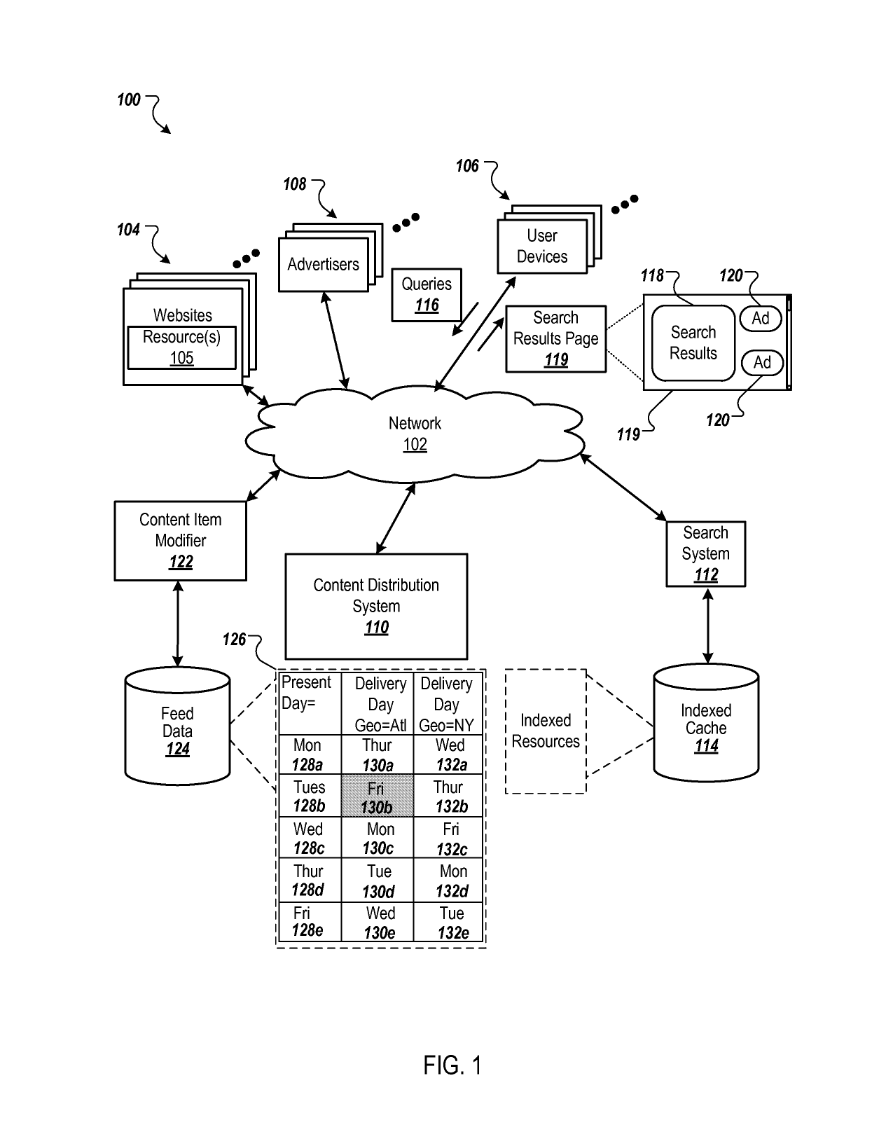

FIG. 1 is a block diagram of an example environment 100 in which content distribution system 110 distributes content to user devices 106. The example environment 100 includes a network 102 such as a local area network (LAN), wide area network (WAN), the Internet, or a combination thereof. The network 102 connects websites 104, user devices 106, advertisers 108, and the advertisement management system 110. The example environment 100 may include millions of websites 104, user devices 106, and advertisers 108.

A website 104 is one or more resources 105 associated with a domain name and hosted by one or more servers. An example website is a collection of web pages formatted in hypertext markup language (HTML) that can contain text, images, multimedia content, and programming elements, e.g., scripts. Each website 104 is maintained by a publisher, e.g., an entity that manages and/or owns the website 104.

A resource 105 is data provided by the website 104 over the network 102 and that is associated with a resource address. Resources include HTML pages, word processing documents, and portable document format (PDF) documents, images, video, and feed sources, to name only a few. The resources can include content, e.g., words, phrases, images and sounds that may include embedded information (such as meta-information in hyperlinks) and/or embedded instructions (such as scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements can be presented. These specified portions of the resource or user display are referred to as advertisement slots.

To facilitate searching of these resources, the environment can include a search system 112 that identifies the resources by crawling and indexing the resources provided by the publishers on the websites 104. Data about the resources can be indexed based on the resource to which the data corresponds. The indexed and, optionally, cached copies of the resources are stored in an indexed cache 114.

User devices 106 can submit search queries 116 to the search system 112 over the network 102. In response, the search system 112 accesses the indexed cache 114 to identify resources that are relevant to the search query 116 (e.g., have at least a threshold relevance score with respect to the search query). The search system 112 identifies the resources in the form of search results 118 and returns the search results 118 to the user devices 106 in search results pages 119.

A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages 119 can also include one or more advertisement slots 120 in which advertisements can be presented. The advertisement slots 120 can also facilitate presentation of other content items instead of, or in addition to, advertisements.

When search results 118 are requested by a user device 106, the content distribution system 110 receives an advertisement request (or another content item request) requesting advertisements (or another content item) to be provided with the search results 118. The advertisement request can include characteristics of the advertisement slots 120 that are defined for the search results page 119. For example, a size of the advertisement slot 120, and/or media types that are eligible for presentation in the advertisement slot 120 can be provided to the content distribution system 110. Similarly, data specifying one or more terms of the search query 116 in response to which the search results page 119 is being provided can also be included in the advertisement request to facilitate identification of advertisements that are relevant to the search query 116. The advertisement request can further include general data about a user to which the advertisement will be presented, geographic information specifying a geographic location associated with the user device 106, and/or other information, such as identified user interests, with which an advertisement can be selected for presentation.

Based on data included in the advertisement request, the content distribution system 110 selects advertisements that are eligible to be provided in response to the advertisement request (“eligible advertisements”). Eligible advertisements can include, for example, advertisements having characteristics that match the characteristics of the advertisement slots 118 and that are identified as relevant to the search query 116.

In some implementations, advertisements that are selected as eligible advertisements by the content distribution system 110 are those advertisements having distribution parameters (i.e., data with which distribution of the advertisement is managed) that match the search query 116 and/or the demographic/geographic information included in the advertisement request. The advertisement management system 110 can select, from the set of eligible advertisements, one or more advertisements for presentation with the search results page 119. Each advertisement can be selected for presentation based, at least in part, on how well a distribution keyword (also referred to as a keyword) for the advertisement matches the search query and/or on the outcome of an auction.

A distribution keyword can match a search query by having the same textual content (“text”) as the search query. For example, an advertisement (or another content item) associated with the distribution keyword “basketball” can be selected for presentation with a search results page that is provided in response to the search query “basketball,” since the search query and the distribution keyword are exactly the same. This is referred to as an exact match.

A distribution keyword can also match a search query by having text that is identified as being sufficiently relevant, or sufficiently similar, to the search query despite having different text than the search query. For example, an advertisement (or another content item) associated with the distribution keyword “basketball” may also be selected for presentation with a search results page that is provided in response to the search query “sports” because basketball is a type of sport, and, therefore, is relevant to the term “sports.”

For purposes of this document, a distribution keyword can be considered to match a search query when a measure of similarity (e.g., semantic or topical similarity) between the distribution keyword and the search query meets a specified threshold value. The measure of similarity can be specified based on a cosine distance between the search query and the distribution keyword, an edit distance between the search query and the distribution keyword, user feedback specifying a measure of similarity between the search query and the distribution keyword, or another indication of similarity between the search query and the distribution keyword (e.g., each of the search query and the distribution keyword being categorized to a same topic in a topical hierarchy).

The content distribution system 110 can also select advertisements for presentation in advertisement slots 120 of a search results page 119 based on results of an auction. For example, the content distribution system 110 can receive bids from advertisers and allocate the advertisement slots to the highest bidders at the conclusion of the auction. The bids are amounts that the advertisers are willing to pay for presentation (or selection) of their advertisement with a search results page. For example, a bid can specify an amount that an advertiser is willing to pay for each 1000 impressions (e.g., presentations) of the advertisement, referred to as a CPM bid. Alternatively, the bid can specify an amount that the advertiser is willing to pay for a user interaction with (e.g., a click-through of or hovering a pointer over) the advertisement or a “conversion” following user interaction with the advertisement.

A conversion occurs when a user consummates a transaction related to an advertisement being provided with a search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, registering an account on a website, etc. Other actions that constitute a conversion can also be used.

In general many advertisers (and other content item providers) would like to provide each user with a customized advertisement that is most likely to result in the user taking some action, such as purchasing a product being advertised. However, because of the wide variety of users that access resources 105 and the search system 112, it can be difficult for an advertiser to provide each user with a customized advertisement. For example, in order to provide a different customized advertisement to each different user group (e.g., males in Atlanta, females in Atlanta, males in New York, females in New York), the advertiser may be required to create a different advertisement for each user group and then specify different distribution criteria (such as distribution keywords or user group information) for each of the different advertisements. The number of different user groups will increase with each additional user attribute that is used to delineate the population of users, as will the number of advertisements that will need to be created and the distribution criteria that will need to be maintained. Therefore, advertisers often limit the number of user groups for which different advertisements are created, which may limit the effectiveness of their advertisements.

The environment 100 includes a content item modifier 122, which is a data processing apparatus that creates a customized content item to provide in response to a content item request. In some implementations, the customized content item is a customized advertisement that is created for presentation with a search results page 119 or another resource 105, and for purposes of example, the description that follows discusses the creation of a customized advertisement. In FIG. 1, the content item modifier 122 is in communication with the content distribution system 110 through the network 102. In some implementations, the content item modifier 122 is implemented to be in communication with the content distribution system 110 or can be implemented as part of the content distribution system 110.

When the content distribution system 110 receives an advertisement request (or another content item request) from a user device 106 (or the search system 112), the content distribution system 110 submits a request to the content item modifier 122 for a customized advertisement to be provided in response to the request. The request for the customized advertisement includes user context data specifying user attributes that are associated with the user and/or the user device 106 to which the customized advertisement will be provided. For example, assuming that a user has previously consented to use of such data for selecting content that is provided to the user, the request can include user profile data (e.g., gender, product category interests, advertisement preferences, or other user profile data) that the user has supplied and/or cookie data specifying one or more resources that have been requested by the user device. The user context data can also include information specifying the search system that is providing the search results page 119 and/or a search query 116 in response to which the search results page 119 is being provided, a resource 105 with which the customized advertisement will be provided, a time of day, day of week, or other data related to the context related to the advertisement request.

Using the user context data in the request, the content item modifier 122 can select a portion of feed data 124 with which a customized advertisement will be created for the request. The feed data 124 is a set of content that is available to be inserted into a customizable advertisement. Each advertiser that creates a customizable advertisement can also create or identify one or more sets of feed data with which customized advertisements will be created. For example, assume that a particular advertiser sells products online and delivers the products to the buyer. In this example, the advertiser may provide feed data specifying, for multiple different user locations, an estimated delivery date to the user location if ordered by a specified time.

For purposes of illustration and continuing with the example above, assume that the advertiser can deliver products to New York in two days, and can deliver products to Atlanta in three days. In this example, the advertiser can create feed data similar to that presented in the feed data table 126. For example, the feed data table 126 includes feed data entries 128a-128e for different days of the week on which the advertisement is presented to users. The feed data table 126 also includes feed data entries 130a-130e that specify, for each of the days on which the advertisement is presented to users, when products will be delivered to buyers in Atlanta if the products are ordered on that day. The feed data table 126 also includes feed data entries 132a-132e that specify, for each of the days on which the advertisement is presented to users, when products will be delivered to buyers in New York if the products are ordered on that day.

The content item modifier 122 can use the feed data entries that are included in the feed data table 126 to create a custom advertisement to be provided in response to an advertisement request. For example, assume that, on a Tuesday, the content item modifier 122 receives an advertisement request including user context data specifying that the user device at which the advertisement will be presented is located in Atlanta (e.g., based on an Internet Protocol address of the Internet Service Provider or based on data provided by the user). In this example, the content item modifier 122 can determine, based on the present day (e.g., the day on which the advertisement request was received) being Tuesday and the user device being located in Atlanta, that the feed data entry 130b will be used to create the custom advertisement. In particular, the content item modifier 122 can insert the content referenced by the feed data entry 130b into a customizable advertisement to specify that if products are ordered by the user today, they will be delivered to the user by Friday.

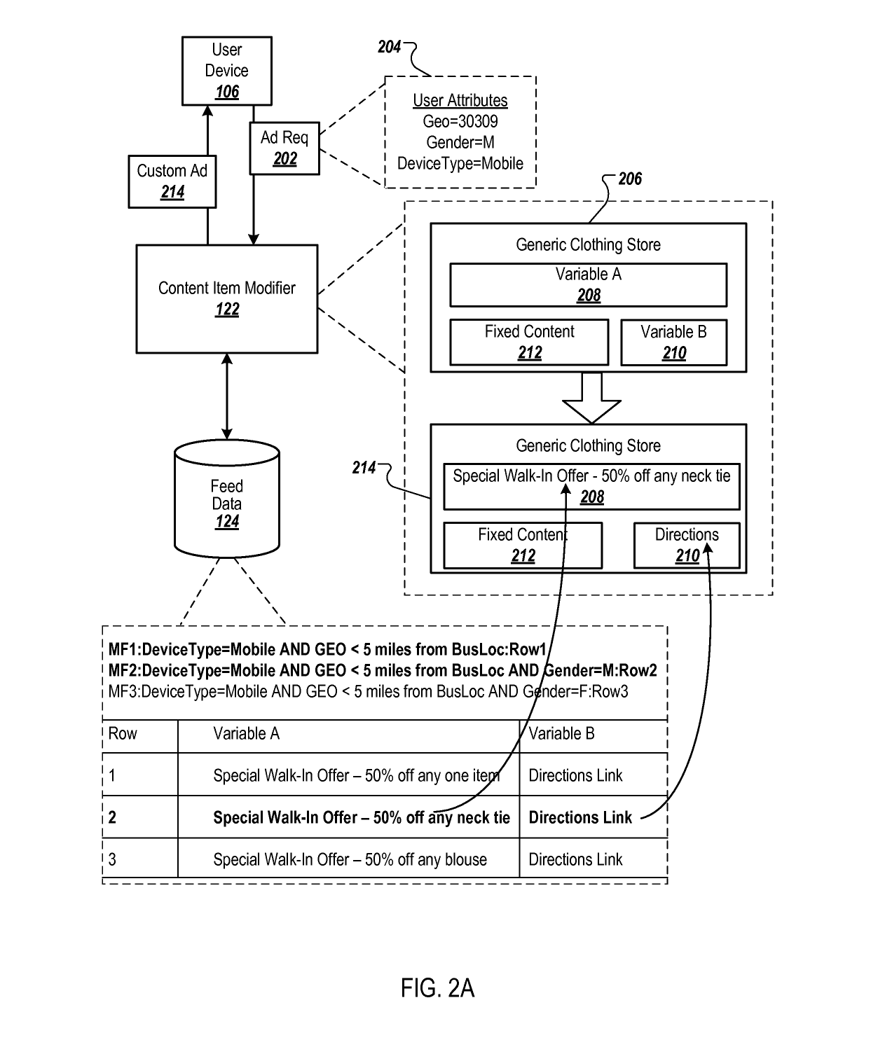

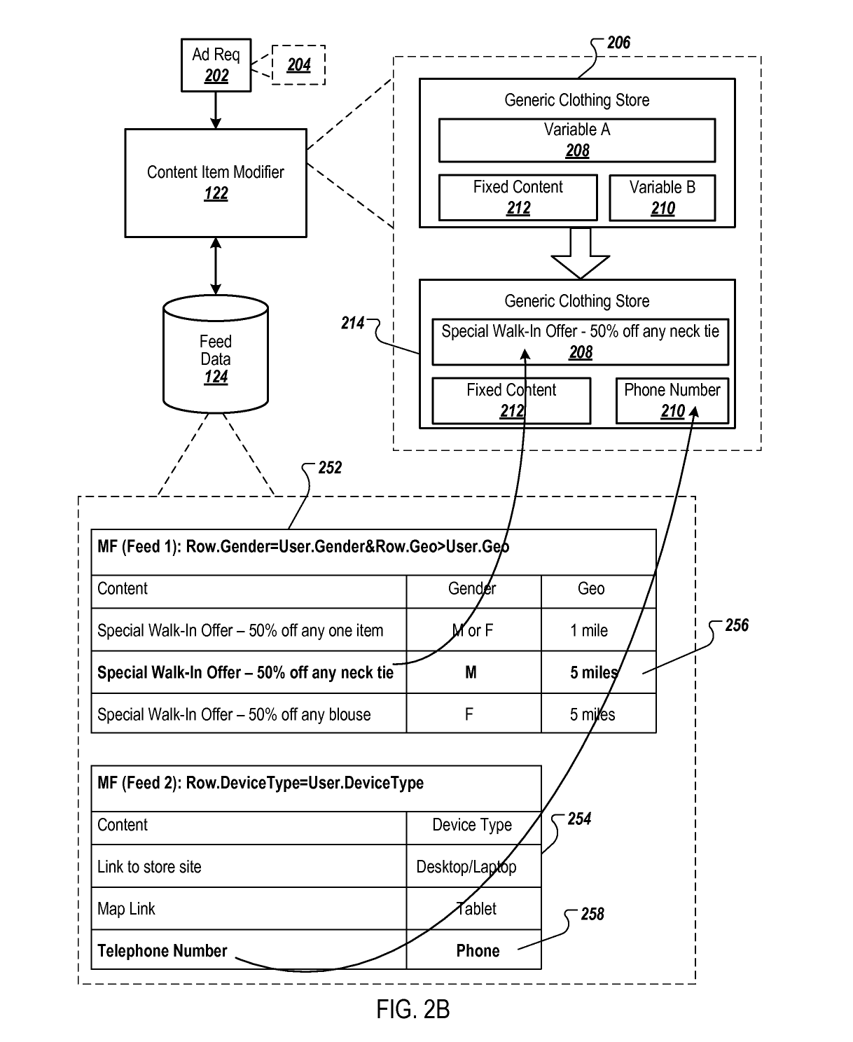

In this example, if the user device was located in New York, the feed data entry 132b would have been used to create a customized advertisement specifying that products ordered by a user in New York would be delivered by Thursday. Thus, the content item modifier 122 can create customized advertisements for users based on user context data that are included in the advertisement request. Therefore, as described in more detail below with reference to FIG. 2A, an advertiser can create as few as a single customizable advertisement (e.g., an advertisement template) that can be populated with content referenced by feed data entries to create many different customized advertisements for many different groups of users. A single customizable advertisement can be populated with content from any number of different feed data entries and the feed data entries that are selected for populating the customizable advertisement can be selected based on criteria specified by the advertiser and/or historical advertisement performance of customizable advertisements that were populated with the content.

FIG. 2A is a block diagram of an example data flow 200 for creating a customized advertisement. The data flow 200 begins with the content item modifier receiving an advertisement request 202. The advertisement request 202 can be received from a user device 106, a search system, or a content distribution system. The advertisement request 202 includes user context data 204 that specify user attributes for the user to whom the advertisement will be presented. For example, the user context data 204 specify that a zip code of 30309 is associated with the user device from which the advertisement request 202 is received. The user context data 204 also specify that the user's gender is male, and that the user device is a mobile user device. The user's gender can be supplied, for example, by a user that creates a user profile and consents to use of that information for purposes of selecting content to be presented to the user.

In some implementations, the user context data can also include, among other contextual data, cookie data for a cookie that has been placed on the user device and is accessible by the search system and/or content distribution system. The cookie data may specify one or more resources that have been previously requested by the user device and/or one or more search queries that have been submitted by the user device. Other user context data that are available can be used in a manner similar to that described below to select content for a customizable advertisement.

This cookie data can be used, for example, to determine whether the user has previously visited a particular page of the advertiser's web site and select content to be included in the customizable advertisement based on the determination. For example, if the cookie data specifies that the user has visited a check out page of the advertiser's web site, but that the user did not complete the transaction, the advertiser may want to offer a discount in the advertisement in an effort to have the user complete a purchase at their site.

The content item modifier 122 selects, based on the user context data 204 and from the feed data 124, content that will be inserted into a customizable advertisement. In some implementations, the content item modifier 122 selects the content based on a matching function (e.g., MF1, MF2, or MF3) that specifies, for one or more combinations of user attributes, which proper subset of the feed data 124 is to be used to create the customized advertisement.

For example, according to FIG. 2A, matching function MF1 specifies that row 1 of the feed data 124 is to be used to create the customized advertisement when the user attributes specify that the device type is a mobile device and the geographic location (“geo”) of the user device is within five miles of the advertiser's business location. For purposes of the following discussion, it is assumed that the zip code 30309 is within five miles of the advertiser's business location.

Matching function MF2 specifies that row 2 of the feed data 124 is to be used to create the customized advertisement when the user attributes specify the that the device type is a mobile device, the geographic location of the user device is within five miles of the advertiser's business location and the user attributes specify that the user is male.

When the matching function MF3 is met, row 3 of the feed data is used to create the customized advertisement. Like matching functions MF1 and MF2, the matching function MF3 requires that the device type be a mobile device and that the geographic location be within five miles of the advertiser's business location. However, matching function MF3 requires that the user attributes indicate that the user is a female in order for row 3 of the fee data to be used.

The content item modifier 122 compares the received user context data 204 to the matching functions to determine whether one or more of the matching functions are met by the user context data. For example, the content item modifier can determine that the user context data 204 include the user attributes required by both matching function MF1 and matching function MF2, such that the user context data 204 can be deemed to meet the requirements of matching function MF1 and the requirements of matching function MF2. The user context data 204 meets the requirements of matching function MF1 and matching function MF2 because the user context data 204 specify that the geographic location of the user device is within five miles of the advertiser's business location and that the user device type is a mobile device, which are both required by each of matching function MF1 and matching function MF2. Further, the user context data 204 specify that the gender of the user is male, which in addition to the foregoing, is required by matching function MF2. However, the user context data 204 does not meet the requirements of matching function MF3, which requires that the gender of the user be female. Thus, in this example, either row 1 or row 2 of the feed data 124 could be used to create the customized advertisement.

When more than one matching function is met by the user context data 204, the content item modifier 122 can select one of the matching functions that will control which portion (e.g., proper subset) of the feed data 124 that will be used to create the customized advertisement. In some implementations, the selection can be based on a specificity of the matching functions. The specificity of a matching function generally increases with the number of user attributes that are specified by the matching functions. For example, a first matching function requiring three specific user attributes be specified by the user context data will generally be considered more specific than a second matching function requiring only two of the three specific user attributes be specified by the use context data. Thus, when the user context data includes each of the user attributes required by both the first and second matching functions, the first matching function may be used to control which portion of the feed data is used since the first matching function is considered more specific.

In the example above, the matching function MF2 is more specific than the matching function MF1 since matching function MF2 requires the user context data 204 to include an additional user attribute (e.g., gender=M) than those required by matching function MF1. Therefore, if the matching function selected based on specificity, matching function MF2 will be selected to specify the portion of the feed data to be used for creating the advertisement. Thus, in this example, row 2 of the feed data 124 will be used to create the customized advertisement.

In some implementations, the selection of a matching function from among the matching functions that are met by the user context data is based on historical performance of advertisements that have been created using the matching rules (e.g., independent of the specificity of the matching rules). For example, assume that advertisements created using matching function MF1 have a higher conversion rate than the advertisements created using matching function MF2. Also assume that matching function MF1 and matching function MF2 are both met by the user context data 204. In this example, the content item modifier 122 can select matching function MF1 as the matching function that will control which portion of the feed data is used to create the advertisement since the performance of matching function MF1 is higher than the performance of matching function MF2. Thus, in this example, row 1 of the feed data 124 would be used to create the advertisement.

The content item modifier 122 uses the content referenced by (e.g., stored at) the portion of the feed data 124 specified by the matching function (e.g., matching function MF2) to create a custom advertisement for the advertisement request 202. In some implementations, the custom advertisement is created by inserting the content that is referenced by the portion of the feed data in place of one or more variables that are included in a customized advertisement, thereby modifying the customized advertisement to create a custom advertisement. The content referenced by the portion of the feed data that is used to create the custom advertisement is referred to as modifying data.

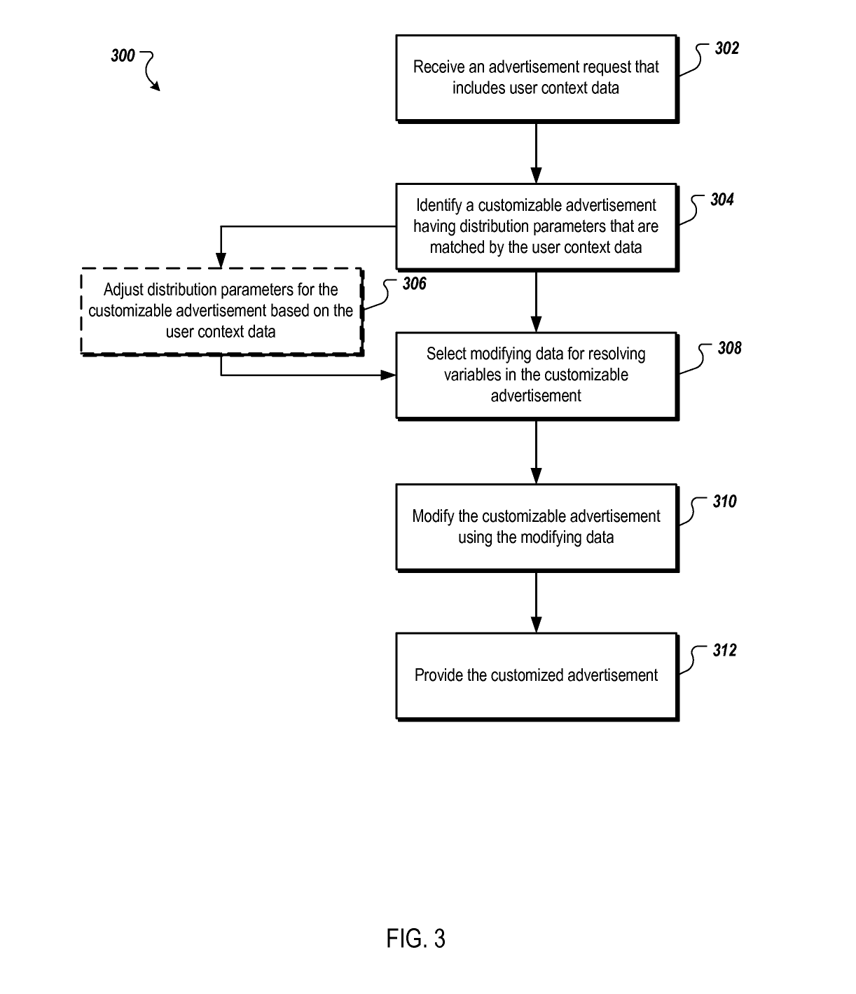

As discussed above, when the content item modifier 122 selects matching function MF2 as the matching function used to create the custom advertisement, row 2 of the feed data 124 is selected to be the modifying data for the custom advertisement. For example, assume that customizable advertisement 206 has been selected to be modified using the modifying data. Customizable advertisement 206 includes two customizable portions 208 and 210 and fixed content 212. The fixed content 212 is content that will be presented in the customizable advertisement 206 irrespective of the portion of the feed data 124 that is used to modify the customizable advertisement 206. For example, the fixed content may be a standardized message that is included with each of the advertiser's advertisements. The selection of a customizable advertisement is discussed with reference to FIG. 3.

The customizable portions 208 and 210 are portions of the customizable advertisement 206 into which feed data 124 can be inserted to customize the customizable advertisement 206. In some implementations, each customizable portion of a customizable advertisement is associated with (e.g., includes) a variable (or another placeholder) that is resolved using the feed data 124. For example, as illustrated by FIG. 2A, the customizable portion 208 includes variable A specifying that the modifying data that correspond to variable A are to be inserted in the customizable portion 208. Similarly, the customizable portion 210 includes variable B specifying that the modifying data that correspond to variable B are to be inserted in the customizable portion 210.

The content item modifier 122 modifies the customizable advertisement 206 by inserting the modifying data from the feed data into the customizable portions 208 and 210. For example, when modifying the customizable advertisement according to matching function MF2, the content item modifier 122 will insert into the customizable portion 208 modifying data from row 2 of the feed data 124 that are used to resolve variable A. In this particular example, the modifying data used to resolve variable A is the text “Special Walk-In Offer—50% off any neck tie”, which is located in row 2 of the “Variable A” column. Thus, the content item modifier 122 will insert this modifying data into the customizable portion 208. Similarly, the content item modifier will insert the “directions link” into the customizable portion 210 since this content is referenced by row 2 of the “Variable B” column in the feed data 124 and Variable B is associated with the customizable portion 210.

Once the customizable advertisement 206 has been modified using the modifying data, the customizable advertisement is considered a customized advertisement 214, and the customized advertisement 214 (or data specifying a location of the customized advertisement 214) is provided to the user device 106.

The feed data 124 can be created and maintained by the advertiser, such that the modifying data that are used to create custom advertisements can be updated through an update to the feed data 124. Because multiple different customizable advertisements can be populated with the feed data, the advertiser can update the content used to create multiple different custom advertisements without being required to update each individual advertisement. For example, assume that two customizable advertisements each include Variable B, and that the advertiser would like to have its business phone number, rather than the directions link, be presented in its advertisements. Here, instead of being required to individually update each of the two customized advertisements, the advertiser can simply update the feed data 124 to globally (or selectively) change variable B to be associated with the advertiser's business phone number. When the two customizable advertisements are subsequently presented, the updated feed content will be inserted into the advertisements, such that the advertiser's business phone number rather than the directions link, will be presented in place of Variable B.

The feed data can be manually entered by the advertiser, or automatically updated from other sources. For example, assume that a hotel advertiser creates feed data that specify a number of each type of room that is available in their hotel, and a lowest price for each type of room. Further assume that the feed data are populated using an inventory management system for the hotel advertiser. In this example, the content item modifier 122 can periodically access the inventory management system to obtain updated availability and pricing information, and update the feed data 124 with the obtained data. If a user receives an advertisement for the hotel advertiser at a first point in time, the advertisement may specify that a particular number of rooms are available at a particular price. However, if the user (or a different user) later receives the advertisement for the hotel advertiser, the advertisement may indicate that fewer rooms are available, and the price may differ relative to that specified in the earlier instance of the advertisement.

The feed data 124 can be obtained from a variety of sources, including landing pages for the advertisements. For example, using the network location of a landing page to which a user is redirected in response to interaction with the advertisement, the content item modifier may request the landing page and obtain data, such as a business address or business phone number for the advertiser. This data can be inserted into the feed data 124 and made available for insertion into the advertiser's customizable advertisements. If the advertiser has multiple locations, the list of locations and corresponding contact information can be included in the feed data 124. The advertiser can specify matching functions that cause the information for a location closest to the user be inserted into the customizable advertisement.

FIG. 2B is a block diagram 250 illustrating another technique for selecting feed data based on a matching function. As described in more detail below, the block diagram 250 illustrates insertion of content into the customizable advertisement 206. The content inserted into the customizable advertisement 206 is selected from multiple different sets of the feed data 124, which are referred to as feeds 252 and 254. The content can be selected from the feeds 252 and 254 in response to an advertisement request 202, which as described above, can include the user context data 204.

In some implementations, the feeds from which content is selected for insertion can be specified based on the variables that are included in the customizable portions 208 and 210 of the advertisement. For example, variable A can include a reference to, or be mapped to, feed 1 252, while variable B can include a reference to, or be mapped to, feed 2 254. In this example, when the content item modifier 122 detects variable A at the customizable portion 208, the content item modifier 122 will refer to feed 1 252 to select content to be presented in the customizable portion 208. Similarly, when the content item modifier 122 detects variable B at the customizable portion 210, the content item modifier 122 will refer to feed 2 254 to select content to be presented in the customizable portion 208.

Each different feed can have a different matching function, and the content item modifier 122 can use the matching function for each feed to select content from that feed. For example, as illustrated by FIG. 2B, feed 1 252 is associated with the matching function “MF (Feed 1),” which is defined as Row.Gender=User.Gender&Row.Geo<User.Geo. In this example, the matching function specifies that the content item modifier 122 should identify a row from the feed 252 in which both the specified gender matches the gender specified by the user context data and the geographic value is less than the geographic value specified by the user context data.

Continuing with the example user context data from FIG. 2A, the content item modifier 122 can determine that the user gender is Male and that the zip code represents a location that is within five miles of the advertiser's geographic location. Using this information, the content item modifier 122 can determine that the row 256 includes a gender that matches the user gender and that the distance of the user location (e.g., within five miles) is less than the geographic value specified for the row. Thus, the content item modifier 122 can select the content in row 256 to populate the customizable portion 208.

Feed 2 254 is associated with the matching function “(MF (Feed 2),” which is defined as Row.DeviceType=User.DeviceType. In this example, the matching function specifies that the content item modifier 122 should identify the row in from the feed 254 in which the device type matches the device type specified by the user context data. In this example, assume that the user device type can be one of desktop/laptop, a tablet device, or a phone device, and that the user context data specifies that the device type is a phone. Using this information, the content item modifier can determine that row 258 includes a device type that matches the device type specified by the user context data. Thus, the content item modifier can select the content from row 258 to populate the customizable portion 210. In this example, the content used to populate the customizable portion 210 is the phone number of the clothing store. If the user device type had been a tablet device, a link providing map of the store location would have been inserted into the customizable portion 210, and if the device type had been desktop or laptop computer, a link to the store's website would have been inserted into the customizable portion 210. In some implementations, matching functions can similarly be used to determine whether an advertisement will include a sitelink and/or which link(s) will be included in the sitelink.

Feed parameters in a matching function used to select content for insertion into a customizable advertisement 206 can include any data available to the content item modifier. For example, an advertiser can create a feed in which the current temperature or other atmospheric conditions are specified, and the matching function can specify that the row from which content is selected specify a temperature value (or another atmospheric condition) greater than, less than, or matches the current temperature. In some implementations the current temperature (or another atmospheric value) can be obtained from a weather information source (e.g., a web page that provides current weather conditions for one or more locations).

Other feed parameters and/or other information sources can be used to create matching functions and determine which row of feed data 124 should be used to populate a customizable advertisement. For example, a time of day parameter can be used to specify when content associated with a particular row of feed data 124 is eligible to be selected for insertion into a customizable advertisement. Other information can also be provided by other online resources, and used to either populate the feed data or as contextual data for determining which row of the feed data meet the matching functions. This information can be provided by the advertiser, obtained from a site specified by the advertiser, or identified by crawling resources from which the information is made available to the public. When the feed data are obtained by crawling resources, the crawl can be performed periodically to maintain updated feed data.

In the event that two rows of a particular feed meet the matching function, the particular row that is selected to populate the advertisement can be selected in a variety of different ways. For example, the advertiser can specify which row has priority in the event that two rows are both eligible. The advertiser could also specify a rotation, such as a 50%-50% split (or another split) where each of the rows will be used an equal portion of the time. Additionally, the advertiser could be enabled to request that the row providing the highest performance (e.g., click-through rate, conversion rate, or another measure of performance) in the context of the current advertisement request (e.g., based on the user context data and any other contextual available information) be selected in the event that multiple different rows are eligible to provide content.

In some implementations, the content item modifier 122, or another data processing apparatus, can perform data quality and compliance operations to verify that the feed data comply with terms of service and to facilitate identification of erroneous data. The data quality and compliance operations can include, for example, an evaluation of prices specified in a feed to ensure that no negative prices have been included, a spell check and/or a grammar check to ensure that the feed data do not include typos or grammatical errors. The quality and compliance operations can also evaluate the feed data to ensure that the content specified by the feed does not include prohibited content (e.g., as specified by terms of service that govern the use of the content item modifier) and/or that the content specified by the feed conforms to style/layout restrictions. For example, the content item modifier 122 can analyze the content of the feed 124 to ensure that the content in each row does not exceed a maximum number of characters that are able to be presented in the customizable portion that will be populated by the content in that row. The content item modifier 122 can provide the advertiser with a report summarizing the outcome of the data quality and compliance operations so that the advertiser can take action based on the report.

The data quality and compliance operations can also include an evaluation of the matching function for a feed. In some implementations, the evaluation of the matching function can include a determination of whether the matching function does not correspond to the data in any of the rows, which would result in no content from the feed data being used to populate the customizable advertisement. For example, assume that the matching function for feed 252 was defined as Row.Gender=User.Gender&Row.Geo<User.Geo&Row.DeviceType=User.DeviceType. In this example, the matching function requires that the user device type match the device type specified in a row of the feed 252. However, the feed 252 does not include data specifying a device type. Therefore, in this example, the matching function would not result in identification of a row of the feed 252 to be used to populate the customizable advertisement 206. When the content item modifier 122 determines that no row in the feed 252 would be identified using the matching function, the content item modifier 122 can provide an alert to the advertiser informing the advertiser that the matching function is invalid, and specify the reason that the matching function is invalid. Similarly, if the matching function will match two or more rows at the same time, the content item modifier can enable the advertiser to specify the manner by which a single row will be selected.

In some implementations, quality and compliance operations can also be performed on customizable advertisements following the customizable portions being populated with the feed data. Evaluation of a customizable advertisement following the population of the customizable portions can facilitate identification of quality and compliance issues that may not be detected based on the evaluation of the feed data itself. For example, it is possible that prior to populating a customizable advertisement with feed data, that customizable advertisement and the feed data are each deemed valid based on the quality and compliance operations, but that after populating the customizable advertisement with the feed data, the resulting advertisement is non-compliant or invalid (e.g., fails to comply with the terms of service or includes grammatical errors).

If the content item modifier 122 determines that a particular combination of feed data result in a non-compliant or invalid advertisement when used to populate a particular customizable advertisement, the content item modifier 122 can provide the advertiser with information specifying the reason that the resulting advertisement has been deemed non-compliant or invalid and/or ways that the advertisement can be adjusted to be compliant or valid.

The content item modifier 122 can take action to prevent distribution of a non-compliant customizable advertisement. In some implementations, the content item modifier 122 can prevent the distribution by preventing a particular feed, or portion of a feed, from being used to populate customizable advertisements. For example, assume that a particular customizable advertisement is deemed non-compliant when populated with content from a particular row of feed data. In this example, the content item modifier 122 can prevent that particular row of the feed data from being used to populate that particular customizable advertisement. Instead, the content item modifier 122 can use default content (e.g., content used when no matching functions are met) in place of the content from that particular row of the feed data.

If a particular portion of the feed is associated with a specified number (or portion) of non-compliant or invalid advertisements, that particular portion of the feed data can be disabled, thereby preventing that particular portion of the feed data from being used to populate any customizable advertisements. Similarly, if a particular feed is associated with a specified number (or portion) of non-compliant or invalid advertisements, that particular feed can be disabled, thereby preventing that data from being used to populate customizable advertisements.

If there are particular combinations of content from the feed that result in a non-compliant or invalid advertisement, the content item modifier 122 can maintain an index identifying those combinations of content. In some implementations, the content item modifier 122 evaluates a customizable advertisement that has been populated using the feed based on the indexed combinations of content. For example, assume that a previously evaluated advertisement created using a particular feed was deemed non-compliant for including the phrase “Term_A Term_B.” In this example, the content item modifier 122, or another data processing apparatus, can evaluate each customizable advertisement populated using the particular feed to determine whether the customizable advertisements includes the phrase “Term_A Term_B.” If this phrase is identified in the customizable advertisement, distribution of the customizable advertisement can be prevented.

Evaluating the advertisements that result from population of the customizable portions and taking action based on that evaluation facilitates identification of non-compliant or invalid advertisements without having to evaluate every combination of content that is possible based on content provided by each available feed. Thus, the computational resources required to identify non-compliant or invalid resources is reduced (e.g., relative to evaluating every possible combination) by only evaluating those combinations of content that are actually selected to populate a customizable advertisement.

FIG. 3 is a flow chart of an example process 300 for providing a customized advertisement. The operations of the process 300 can also be used to provide other customized content items. Operations of the process 300 can be implemented, for example, by a data processing apparatus, such as the content item modifier 122 and/or the content distribution system 110 of FIG. 1. The process 300 can also be implemented as instructions stored on computer storage medium such that execution of the instructions by a data processing apparatus cause the data processing apparatus to perform the operations of the process 300.

An advertisement request including user context data is received (302). The advertisement request can be received from a user device or from a content distribution system that provides advertisements to user devices that have requested an advertisement. The user context data are data that characterize a presentation opportunity for an advertisement that is presented in response to the advertisement request.

In some implementations, the user context data include user attributes that describe a user to whom and/or a user device at which the advertisement provided in response to the request will be presented. For example, the user context data can specify whether the user device at which the advertisement will be presented is a mobile device or a desktop device (e.g., a device that has not been classified as a mobile device). The user context data can also include data specifying a screen size for the user device and/or a generalized location of the user device. The user context data can also include data (e.g., gender) that the user has supplied and/or authorized be used for selecting content to be provided to the user.

The user context data can also specify a search query for which a search results page is being provided to the user device and on which a selected advertisement will be presented. For example, assume that a user submits the search query “hotel” to a search system. In this example, the search request may include data specifying that an advertisement that is selected to be provided to the user will be presented with a search results page including search results responsive to the search query “hotel.”

The user context data can further include cookie data for a cookie that is accessible by the content distribution system. The cookie data can specify one or more resources that have been requested by the user device (e.g., from a search results page) and/or data indicating whether the user performed a transaction at any of the specified resources. For example, the cookie data can specify that the user device requested a web page through interaction with a search results and eventually navigated to a check-out page of the web site for the requested web page. If the user made a purchase after visiting the check-out page, the cookie data may include a data flag indicating that a purchase was made. If the user did not make a purchase after visiting the check-out page, the cookie data may include a data flag indicating that a purchase was not made, or the lack of a data flag indicating that a purchase was made can be interpreted to mean that no purchase was made.

A customizable advertisement having distribution parameters matching the user context data is identified (304). The customizable advertisement is an advertisement that includes one or more variables that are resolved based on the user context data. For example, as discussed above with reference to FIGS. 2A and 2B, a customizable advertisement can include variables that are placeholders for content that is inserted into the advertisement based on an evaluation of the user context data and matching functions that have been specified for the customizable advertisement.

In some implementations, the customizable advertisement is selected based on a determination that the search query identified by the user context data matches a distribution keyword for the customizable advertisement. For example, assume that a particular customizable advertisement for a hotel chain uses the distribution keyword “hotel” to control distribution of the customizable advertisement. In this example, the customizable advertisement will be eligible to be distributed when the user context data includes data indicating that the user device submitted the search query “hotel.” As discussed above with reference to claim 1, there are other search queries that may be deemed to match the distribution keyword “hotel.”

Additionally, or alternatively, the customizable advertisement can be selected based on a determination that one or more user attributes match the distribution parameters for the customizable advertisement. For example, assume that an advertiser has requested that a particular set of advertisements be distributed when, in addition to the distribution keyword matching the search query, the user device is located within a specified distance of a business location for the advertiser. In this example, the particular set of advertisements will not be eligible for distribution if either the user device is not within the specified distance of the business location for the advertiser or the search query that was submitted by the user does not match a distribution keyword for the particular set of advertisements. Thus, different customizable advertisements can be selected to different user groups based on the user context data.

In some implementations, distribution parameters for the customizable advertisement are optionally adjusted based on the user context data (306). The adjustment of the distribution parameters can include adjusting a bid for the customizable advertisement based on the user context data. The adjustment of the bid can be based on a bid change condition being met. The bid change condition can specify one or more attributes that, when included in the user context data, will trigger a change of the bid for the customizable advertisement.

For example, assume that an advertiser specifies that the bid for a customizable advertisement should be doubled when the user context data specify that the user is in the same city as a business location for the advertiser. Further assume that the advertiser specifies that the bid should not be adjusted when the user context data specifies that the user is not located in the same city as the business location. In this example, the bid for the advertisement will be doubled (i.e., set to a specified value) when the user context data indicates that the user is located in the same city as the business location of the advertiser.

Other bid change conditions can also be specified for a customizable advertisement. In some implementations, an advertiser may specify variable bid that changes based on a distance of the user from the business location for the advertiser. For example, the advertiser can specify a maximum bid and indicate that the bid should decrease in proportion to a distance of the user from the business location for the advertiser. In this example, the advertiser will pay up to the maximum bid for users that are within a specified distance of (e.g., within 5 miles of or in a same city as) the business location of the advertiser (e.g., based on geographic data included in the user context data). However, the price that the pay for distributing the advertisement to users will decrease based on the distance of the users to the business location.

Data specifying the bid change condition can be included in the feed data, and a matching function similar to that described above with reference to FIGS. 2A and 2B can be used to identify the portions of the feed data that should be used to modify the bid. Thus, an advertiser can specify variable bidding criteria for multiple different advertisements by creating feed data that includes the bid change conditions and making the feed data available to the content item modifier 122 and/or the content distribution system. Additionally, the advertiser can adjust the bid change conditions for the multiple different advertisements by making a change to the feed data, rather than having to individually change the bid change condition for each of the advertisements that use the feed data to evaluate the bid change condition.

Modifying data are selected for resolving variables that are included in the customizable advertisement (308). As described above with reference to FIGS. 2A and 2B, the modifying data can be selected according to matching functions that have been created for the customizable advertisement. Each matching function can specify particular attributes that must be specified in the user context data (or obtainable based on the use context data) for a particular portion of feed data to be selected as modifying data for the customizable advertisement. For example, assume that a particular matching function species that a particular portion of the feed data is to be used to resolve the variables when the user is within 20 miles of a business location for the advertiser. In this example, the particular portion of the feed data will not be used to resolve the variables when the user context data indicates that the user device is 50 miles from a business location for the advertiser.

In some implementations, matching functions (or other modifying data selection attributes) can specify time periods during which the matching functions are valid. For example, if an advertiser's online customer service chat available Monday-Friday from 8 am to 8 pm, the matching function that causes a chat initiation link to be inserted into the advertisement may only be valid Monday-Friday from 8 am to 8 pm. In particular, the matching function can specify that a current time (e.g., a time at which the advertisement request is received) be within a specified time period for the matching function to be met. Alternatively, the feed data can be structured in a manner such that portions of the feed can be made available only during specified periods.

Additionally, or alternatively, the portion of the feed data that are selected as the modifying data for the customizable advertisement can be based on performance measures for various portions of the feed data that have previously been used to resolve the variables for the customizable advertisement. In some implementations, the performance measure for a particular customizable advertisement can be determined based on presentation summary data for the particular customizable advertisement. The summary data specify, for individual presentations of the customizable advertisement, the user context data for a previous advertisement request in response to which the customizable advertisement was presented. The summary data also specify, for each presentation, performance data specifying whether user interaction with the presented advertisement occurred. For example, the performance data can specify whether a user clicked on the presented advertisement and/or hovered a pointer over the presented advertisement for at least a minimum specified period of time. In some implementations, the performance data can also, or alternatively, specify whether after user interaction with the presented advertisement, the user performed an action that constitutes a conversion.

The summary data can further include variable resolution data specifying the modifying data that were inserted in place of the variables of the customizable advertisement. For example, the variable resolution data can specify a row and/or column of feed data that were used to resolve each variable. Alternatively, or additionally, the variable resolution data can specify data identifying actual content that was inserted into the customizable advertisement since the feed data may change over time.

In some implementations, performance measures are determined for each distinct set of modifying data that have been used to resolve the variables of the customizable advertisement. For example, assume that two different sets of modifying data were used to resolve the variables for the customizable advertisement. In this example, a separate performance measure can be determined for each distinct set of modifying data based on the performance data corresponding to those presentations of the advertisement for which the distinct set of modifying data were used to resolve the variables of the customizable advertisement.

The performance measures can be used to select the modifying data, for example, when multiple different matching functions are met by the user context data. For example, each of the different proper subsets of the feed data that are referenced by the matching functions can be identified as candidate modifying data for resolving the variables. In this example, the candidate modifying data that are selected as the modifying data can be that set of candidate modifying data having a highest performance measure (or at least threshold performance measure). The performance measure with which the modifying data are selected can be a click through rate, a conversion rate, or another measure of performance of the advertisement when populated with the modifying data.

The performance measures can be further specified on a per-user-context basis. In some implementations, the per-user-context based specification of performance measures can include a determination that a particular distinct set of modifying data was used to resolve the variables in response to advertisement requests that specified two different distinct sets of user context data. For example, assume that the matching function that was used to select the modifying data did not specify a device type that was required to be specified by the user context data. Further assume that the same set of modifying data, specified by the matching function, was used to resolve the variables in response to advertisement requests from both mobile devices and desktop devices. In this example, a first performance measure for the set of modifying data can be determined for presentations of the advertisement to mobile devices and a second performance measure for the set of modifying data can be determined for presentations of the advertisement to desktop devices (e.g., devices not identified as mobile devices). Thus, the performance measures can be determined on a per-user-context basis.

These performance measures can be used, for example, to select modifying data for the customizable advertisement or provided to an advertiser in the form of a report that the advertiser can use to determine whether they want to modify their advertising campaign. In some implementations, when two matching functions are met by the user context data, the per-user-context performance measures can be used to determine which set of modifying data will be selected to modify the customizable advertisement. For example, assume that two matching functions are met by a particular set of user context data, but that the user context data includes additional attributes not required by either of the two matching functions. In this example, in addition to those attributes required by the matching functions, the attributes not required by the two matching functions can be used to identify per-user-context performance measures for the modifying data. In turn, the set of modifying data having the highest per-user-context performance measure can be selected as the modifying data with which the variables will be resolved.

The customizable advertisement is modified using the modifying data (310). As described above with reference to FIG. 2, the modifying data can be inserted into the customizable advertisement in place of the variables that are included in the advertisement.

The customized advertisement is provided in response to the advertisement request (312). The customized advertisement can be provided to the user device that requested the advertisement or to a content distribution system that manages the distribution of content to user devices.

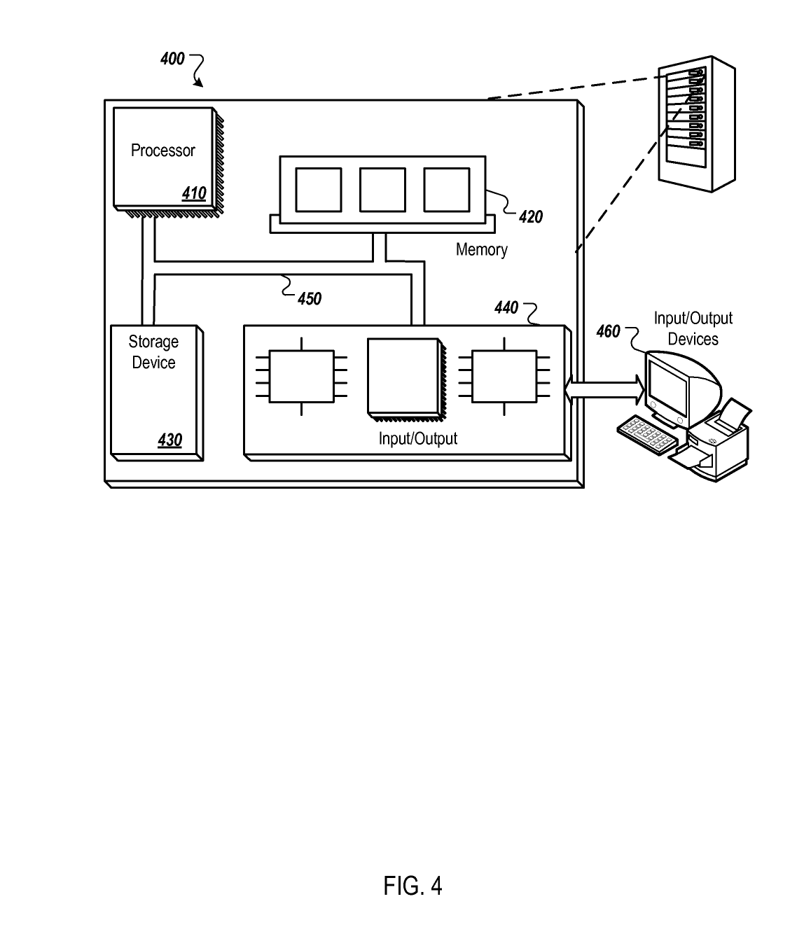

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal and non-transitory, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1-20. (canceled)

21. A method performed by one or more data processing apparatus, the method comprising:
receiving a content request specifying a geographic location associated with a user device;
identifying, by the one or more data processing apparatus, a content item to be provided to the user device in response to the content request;
determining, by the one or more data processing apparatus and based on the geographic location, that an extender condition for the identified content item is met;
identifying, from a content feed specified by a provider of the content item and in response to the extender condition being met, additional content based on the geographic location; and
providing, by the one or more data processing apparatus, the additional content for presentation in an extended portion of the content item that is presented in response to the extender condition being met.

22. The method of claim 21, comprising:
receiving a second content request specifying a different geographic location; and
providing different additional content for presentation in the extended portion of the content item in response to receiving the second content request.

23. The method of claim 21, wherein identifying a content item to be provided to the user device comprises identifying an advertisement having distribution parameters that match user attributes specified by the content request.

24. The method of claim 23, comprising:
determining that the advertisement includes one or more variables that are resolved based on the user attributes; and
selecting a portion of feed data to which the one or more variables will be resolved, the selection being based on performance measures for portions of the feed data that have been previously used to resolve the one or more variables in response to previous content requests that included matching user attributes.

25. The method of claim 24, comprising including, in place of the one or more variables, the selected portion of the feed data.

26. The method of claim 23, comprising:
determining a bid for the advertisement based on the user attributes; and
providing the bid to an advertisement selection process.

27. The method of claim 26, wherein determining a bid for the advertisement comprises:
determining that at least one of the user attributes in the received content request matches a bid change condition; and
setting the bid for the advertisement to a value corresponding to the at least one user attribute.

28. A system, comprising:
a data store storing feed data for a provider of a content item; and
one or more computers that interact with the data store and execute instructions that cause the one or more computers to perform operations comprising:
receiving a content request specifying a geographic location associated with a user device;
identifying a content item to be provided to the user device in response to the content request;
determining, based on the geographic location, that an extender condition for the identified content item is met;
identifying, from a content feed specified by the provider of the content item and in response to the extender condition being met, additional content based on the geographic location; and
providing the additional content for presentation in an extended portion of the content item that is presented in response to the extender condition being met.

29. The system of claim 28, wherein the instructions cause the one or more computers to perform operations comprising:
receiving a second content request specifying a different geographic location; and
providing different additional content for presentation in the extended portion of the content item in response to receiving the second content request.

30. The system of claim 28, wherein identifying a content item to be provided to the user device comprises identifying an advertisement having distribution parameters that match user attributes specified by the content request.

31. The system of claim 30, wherein the instructions cause the one or more computers to perform operations comprising:
determining that the advertisement includes one or more variables that are resolved based on the user attributes; and
selecting a portion of feed data to which the one or more variables will be resolved, the selection being based on performance measures for portions of the feed data that have been previously used to resolve the one or more variables in response to previous content requests that included matching user attributes.

32. The system of claim 31, wherein the instructions cause the one or more computers to perform operations comprising including, in place of the one or more variables, the selected portion of the feed data.

33. The system of claim 30, wherein the instructions cause the one or more computers to perform operations comprising:
determining a bid for the advertisement based on the user attributes; and
providing the bid to an advertisement selection process.

34. The system of claim 33, wherein determining a bid for the advertisement comprises:
determining that at least one of the user attributes in the received content request matches a bid change condition; and
setting the bid for the advertisement to a value corresponding to the at least one user attribute.

35. A computer storage device storing instructions that when executed by one or more computers cause the one or more computers to perform operations comprising:
receiving a content request specifying a geographic location associated with a user device;
identifying a content item to be provided to the user device in response to the content request;
determining, based on the geographic location, that an extender condition for the identified content item is met;
identifying, from a content feed specified by a provider of the content item and in response to the extender condition being met, additional content based on the geographic location; and
providing the additional content for presentation in an extended portion of the content item that is presented in response to the extender condition being met.

36. The computer storage device of claim 35, wherein the instructions cause the one or more computers to perform operations comprising:
receiving a second content request specifying a different geographic location; and
providing different additional content for presentation in the extended portion of the content item in response to receiving the second content request.

37. The computer storage device of claim 35, wherein identifying a content item to be provided to the user device comprises identifying an advertisement having distribution parameters that match user attributes specified by the content request.

38. The computer storage device of claim 37, wherein the instructions cause the one or more computers to perform operations comprising:
determining that the advertisement includes one or more variables that are resolved based on the user attributes; and
selecting a portion of feed data to which the one or more variables will be resolved, the selection being based on performance measures for portions of the feed data that have been previously used to resolve the one or more variables in response to previous content requests that included matching user attributes.

39. The computer storage device of claim 38, wherein the instructions cause the one or more computers to perform operations comprising including, in place of the one or more variables, the selected portion of the feed data.

40. The computer storage device of claim 37, wherein the instructions cause the one or more computers to perform operations comprising:
determining that at least one of the user attributes in the received content request matches a bid change condition;
setting a bid for the advertisement to a value corresponding to the at least one user attribute; and
providing the bid to an advertisement selection process.
